(19) United States
(12) Patent Application Publication
(10) Pub. No.: US 2026/0192196 A1
(43) Pub. Date: Jul. 9, 2026

(54) IMAGE RENDERING WITH MULTIPLE VIEWS USING NEURAL NETWORK-BASED IMAGE GENERATION

(71) Applicant: NVIDIA Corporation, Santa Clara, CA (US)

(72) Inventors: Ram RANGAN, Chennai (IN); Deep SHEKHAR, Bengaluru (IN); Mark STEPHENSON, Austin, TX (US); Vladimir BONDAREV, Gilze (NL); Seth SCHNEIDER, San Jose, CA (US)

(73) Assignee: NVIDIA Corporation, Santa Clara, CA (US)

(21) Appl. No.: 19/008,996

(22) Filed: Jan. 3, 2025

(51) Int. Cl. A63F 13/52; G06F 3/01; G06T 1/20; G06T 13/40; G06T 15/00

(52) U.S. Cl. CPC A63F 13/52; G06F 3/013; G06T 1/20; G06T 13/40; G06T 15/005

(57) ABSTRACT

Various examples, systems, and methods are disclosed relating to neural networks for generating images for multiple views while reducing compute usage. A system can perform at least one operation on an image frame in a sequence of frames. The at least one operation can correspond to an image processing pipeline associated with rendering and generation portions of the image frame. The system can select at least one portion of the image frame to render based at least on application data and information from a detector, and can generate remaining portions of the image frame. The system can perform, using at least one machine learning model, interpolation for generating portions of the image frame.

### BACKGROUND

Some systems, such as consoles or gaming systems, provide multiple views to be presented simultaneously, such as on a same display device. This can include, for example, split-screen games in which multiple players can each be provided a corresponding screen (e.g., portion of the overall display area to be presented by a display device) by the system. However, performance of such games can decrease under split-screen conditions. Previous methods of reducing compute usage for rendering multiple views have involved obscuring or selectively presenting different portions of a display for different users. While these methods are able to reduce compute usage, it may negatively impact the experience of the user by obscuring important information.

### SUMMARY

Implementations of the present disclosure relate to image rendering with multiple views using neural network-based image generation. Systems and methods are disclosed that can utilize machine learning models, such as neural networks, to generate image data for a given view. In contrast to conventional systems, such as those described above, systems and methods in accordance with the present disclosure can allow for smooth animation while reducing use of computational resources by rendering some views of a subset of a sequence of frames and generating views for the remaining frames in the sequence of frames.

At least one aspect relates to one or more processors. The one or more processors can include processing circuitry to render, based at least on data of an application for which to present a sequence of frames, a first portion of a first frame and a second portion of the first frame. The processing circuitry can render, based at least on the data, a first portion of a second frame of the sequence of frames, the first portion of the second frame associated with the first portion of the first frame. The processing circuitry can generate, based at least on the data and the second portion of the first frame, a second portion of the second frame, the second portion of the second frame associated with the second portion of the first frame. The processing circuitry can present the sequence of frames using a display device.

In some implementations, the processing circuitry can present the sequence of frames at a frame rate, to render the respective first portion of each frame of the sequence of frames at the frame rate, and to render the respective second portion of each frame of the sequence of frames at a lower frame rate than the frame rate. The processing circuitry can include at least one of a neural network or an optical flow processor to interpolate the second portion of the second frame.

In some implementations, the first portion of the first frame corresponds to a first representation of one or more scenes indicated by the application, and the second portion of the first frame corresponds to a second representation of the one or more scenes different from the first representation. In some implementations, the processing circuitry can detect, according to an eye tracker, a direction in which a user of the application is viewing the display device, wherein the application comprises a game. The processing circuitry can map the first portion to a location at which the direction intersects the first frame.

In some implementations, the processing circuitry is to use a first processing thread to render the first portion of the first frame and the first portion of the second frame, and to use a second processing thread to render the second portion of the first frame. The processing circuitry can interpolate the second portion of the second frame based at least on data relating to the application received from a remote device.

At least one aspect relates to a system. The system can include one or more processors to execute operations including rendering, based at least on data of an application for which to present a sequence of frames, a first portion of a first frame of the sequence of frames and a second portion of the first frame. The operations can include rendering, based at least on the data, a first portion of a second frame of the sequence of frames, the first portion of the second frame associated with the first portion of the first frame. The operations can include interpolating, based at least on the data and the second portion of the first frame, a second portion of the second frame, the second portion of the second frame associated with the second portion of the first frame. The operations can include present, using a display device, the sequence of frames.

In some implementations, the one or more processors can present the sequence of frames at a frame rate. The one or more processors can render the respective first portion of each frame of the sequence of frames at the frame rate. The one or more processors can render the respective second portion of each frame of the sequence of frames at a lower frame rate than the frame rate.

In some implementations, the one or more processors include at least one of a neural network or an optical flow processor to interpolate the second portion of the second frame. In some implementations, the first portion of the first frame corresponds to a first representation of one or more scenes indicated by the application. The second portion of the first frame can correspond to a second representation of the one or more scenes different from the first representation.

In some implementations, the one or more processors can detect, according to an eye tracker, a direction in which a user of the application is viewing the display device, wherein the application comprises a game. The one or more processors can map the first portion to a location at which the direction intersects the first frame.

In some implementations, the one or more processors are to use a first processing thread to render the first portion of the first frame and the first portion of the second frame, and to use a second processing thread to render the second portion of the first frame. The one or more processors can interpolate the second portion of the second frame based at least on data relating to the application received from a remote device.

At least one aspect relates to a method. The method can include rendering, based at least on application data, a first portion of a first frame of a sequence of frames and a second portion of the first frame. The method can include rendering, based at least on the data, a first portion of a second frame of the sequence of frames, the first portion of the second frame associated with the first portion of the first frame. The method can include interpolating, based at least on the data and the second portion of the first frame, a second portion of the second frame, the second portion of the second frame associated with the second portion of the first frame. The method can include presenting, using a display device, the sequence of frames.

In some implementations, the method includes presenting the sequence of frames at a frame rate. The method can include rendering the respective first portion of each frame of the sequence of frames at the frame rate. The method can include rendering the respective second portion of each frame of the sequence of frames at a lower frame rate than the frame rate.

In some implementations, the method includes the first portion of the first frame corresponds to a first representation of one or more scenes indicated by the application. In some implementations, the method includes the second portion of the first frame corresponds to a second representation of the one or more scenes different from the first representation.

### BRIEF DESCRIPTION OF THE DRAWINGS

The present systems and methods for image rendering with multiple views using neural network-based image generation are described in detail below with reference to the attached drawing figures, wherein:

FIG. 1 is a block diagram of an example of a system, in accordance with some implementing some embodiments of the present disclosure;

FIG. 2 is a block diagram of an example display device, in accordance with implementing some embodiments of the present disclosure

FIG. 3 is a flow diagram of an example of a method for generating images for multiple views, in accordance with implementing some embodiments of the present disclosure.

FIG. 4A is a block diagram of an example generative language model system suitable for use in implementing at least some embodiments of the present disclosure;

FIG. 4B is a block diagram of an example generative language model that includes a transformer encoder-decoder suitable for use in implementing at least some embodiments of the present disclosure;

FIG. 4C is a block diagram of an example generative language model that includes a decoder-only transformer architecture suitable for use in implementing at least some embodiments of the present disclosure;

FIG. 5 is a block diagram of an example content streaming system suitable for use in implementing some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to image rendering with multiple views using neural network-based image generation. For example, systems and methods as described herein can generate images for multiple views, such as to provide split-screen experiences on a single display device. Some systems, such as consoles or gaming systems, provide multiple views to be presented simultaneously, such as on a same display device. This can include, for example, split-screen games in which multiple players can each be provided a corresponding screen (e.g., portion of the overall display area to be presented by a display device) by the system. However, performance of such games can decrease under split-screen conditions. For example, the performance of split-screen games can be inversely proportional to the number of users. This can be due to the increased CPU overhead of processing more streams of commands, as well as GPU overhead of rendering for each of the multiple screens. As criteria for games and other experiences (e.g. and without limitation, resolution, data rate, frame rate, latency, originality of generated images and/or video) have increased, it can be challenging for a system to satisfy such criteria in split-screen or other multiple view modes.

Systems and methods in accordance with the present disclosure can allow for various modes of multiple views to be rendered, e.g., for presentation in a split-screen format. For example, the system can generate a sequence of frames, where each frame corresponds to a plurality of views, e.g., at least a first view and a second view. The views can correspond to different portions, e.g., partitions, of each frame, such as different groups of pixels of each frame. The system can render image data for the first view for each frame of the sequence of frames. The system can render image data for the second view for a subset of the sequence of frames, and can generate (e.g., interpolate) image data for the second view for one or more remaining frames of the sequence of frames. For example, the system can render image data for the second view of the sequence of frames at a lower frequency (e.g., frame rate) than rendering for the first view, or other lower performance parameters such as resolution. For example, the system can render image data for the first view at a target frame rate (e.g., 60 frames per second (fps) or 120 fps), can render image data for the second view at a lower frame rate (e.g., 30 fps or 15 fps), and can interpolate image data for the remaining frames. This can allow for the system to achieve smooth animation while reducing compute resource usage.

In some implementations, the system generates the remaining frames for a given view based at least on the image data of one or more rendered frames or data used to render the one or more rendered frames. For example, the system can use one or more neural networks, diffusion models, and/or optical flow algorithms to generate the remaining frames. This process may include, for instance, interpolating the remaining frame(s) based on one or more rendered frames.

The system can allow for various use cases of multiple views (e.g., viewports, screens), including but not limited to for gaming applications. This can include, for example, split-screen games in which multiple players can each be provided a corresponding screen (e.g., portion of the overall display area to be presented by a display device) by the system. For example, the system can allow for a team view, such as where the first view is used to present rendered images relating to a user of the system, and can present at least some generated images relating to content of a remote user (e.g., teammate). The system can allow for virtual devices in the in-game experience, e.g., to present a portable electronic device screen. The system can allow for picture-in-picture features, e.g., sighting devices, such as scopes. The system can allow for rear views relative to a movement direction of the primary view, such as for rear views of cameras. The system can allow for multiple views of a cut scene, such as split-screen cut screens. The system can allow for maps, drone views and/or bird's eye views, or various other additional or alternative views of an environment. The system can present traversals of scenes into future states, such as to provide predicted views of future states relative to a current state presented in a given view. The system can generate views for multiplayer use cases based at least on data received via a network connection from a remote device.

In some implementations, the system generates the views based at least on eye tracking data. For example, the system can identify, using eye tracking data, a selection of a view amongst a plurality of views, and can perform at least some interpolation for other views of the plurality of views than the selected view. This can allow the system to dynamically determine a primary view for rendering relative to alternative views to have interpolated frames.

In some implementations, the system dynamically determines an interpolation rate (e.g., a number of interpolated frames between two rendered frames) for alternative views. The interpolation rate for alternative views can vary and can be configured differently for each view of the alternative views.

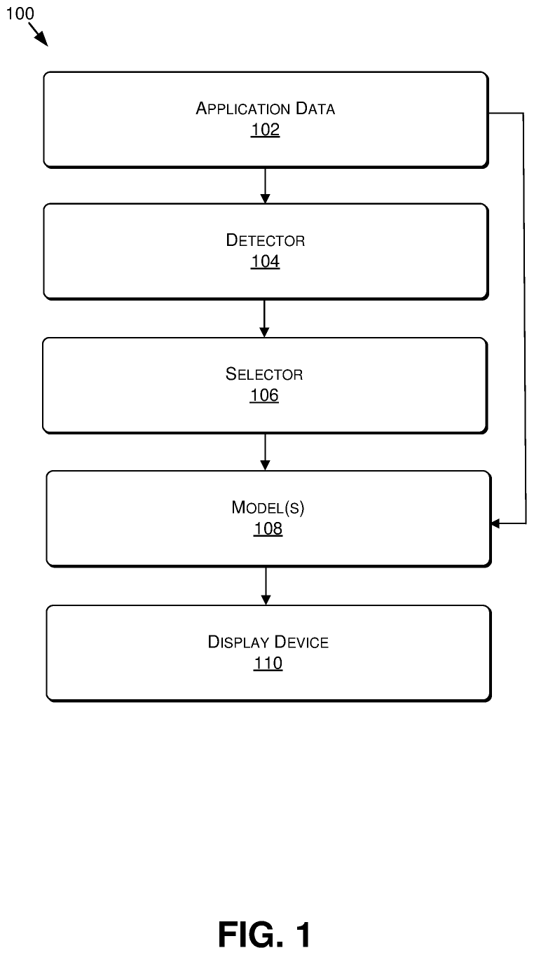

With reference to FIG. 1, FIG. 1 is an example block diagram of a system 100 for generating images for multiple views, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory. The system 100 can include any function, model (e.g., machine learning model), operation, routine, logic, or instructions to perform functions such as operating one or more of detector 104, selector 106, and/or machine learning model 108, as described herein, such as to configure machine learning models to operate as generative models and/or diffusion models.

The system 100 can include or be coupled with one or more data sources such as application data 102. The application data 102 can include or the system 100 can receive the application data 102 from any of various databases, data sets, data repositories, or from a remote device via a network connection, for example. As described further herein, the system 100 can use at least a subset of the application data 102 to configure models 108, such as to configure the models 108 to generate image data based at least on application data 102.

The application data 102 can include, without limitation, data such as any one or more of text, speech, audio, image, and/or video data. Images (including video) of the data 102 can correspond to one or more views of a scene captured by an image capture device (e.g., camera), or images generated computationally, such as simulated or virtual images or video (including by being modifications of images from an image capture device). The images can each include a plurality of pixels, such as pixels arranged in rows and columns. The images can include image data assigned to one or more pixels of the images, such as color, brightness, contrast, intensity, depth (e.g., for three-dimensional (3D) images), or various combinations thereof. The data 102 can include videos and/or video data structured as a plurality of frames (e.g., image frames, video frames), such as in a sequence of frames, where each frame is assigned a time index (e.g., time step, time point) and has image data assigned to one or more pixels of the images.

Referring further to FIG. 1, the system 100 can generate the application data 102 responsive to execution of a game and/or can receive the application data 102 from a game. The game can be a single player or multiplayer game in which one or more players are to direct an avatar or playable character through a scene or virtual environment in order to perform various tasks. A player can utilize a player device to execute play of the game during a game session through a gaming application. The player device can be any appropriate device including at least one processor, non-transitory memory, and storage for executing game content, or at least for receiving game content and causing that content to be presented to a player using a display, headset, or other such mechanism. Such devices include, for example, desktop computers, notebook computers, smartphones, tablet computers, gaming consoles, set-top boxes, and the like. In some embodiments the game can have one or more online aspects, which require the player device to communicate with at least one game server over at least one network. The network(s) can include any appropriate network for communicating application data, as can include a wired or wireless network, the Internet, a cellular network, an Ethernet, a local area network (LAN), a peer-to-peer network, etc. The game server can host a game session that can involve players using other player devices that communicate over at least one of the networks, which can be the same as, or different from, one used by the player device. The system can render various objects for display on the player device, as can include the player's avatar, a weapon being held by that avatar, targets, buildings, background elements, and the like. These objects, as well as their position, can change significantly during gameplay.

The system 100 can implement, use, train, update, and/or configure one or more models 108 (e.g., machine learning models). The machine learning models 108 can include machine learning models or other models that can generate target outputs based on various types of inputs. The machine learning model 108 can include one or more neural networks. The neural network can include an input layer, an output layer, and/or one or more intermediate layers, such as hidden layers, which can each have respective nodes. The system 100 can train/update the neural network by modifying or updating one or more parameters, such as weights and/or biases, of various nodes of the neural network responsive to evaluating candidate outputs of the neural network.

The models 108 can be or include various neural network models, including models that are effective for operating on or generating data including but not limited to image data, video data, text data, speech data, audio data, or various combinations thereof. The machine learning models 108 can include one or more transformers, convolutional neural networks (CNNs), U-nets, vision transformers, recurrent neural networks (RNNs), long short-term memory (LSTM) models, other network types, or various combinations thereof. The machine learning models 108 can include generative models, such as generative adversarial networks (GANs), Markov decision processes, variational autoencoders (VAEs), Bayesian networks, autoregressive models, autoregressive encoder models (e.g., a model that includes an encoder to generate a latent representation (e.g., in an embedding space) of an input to the model (e.g., a representation of a different dimensionality than the input), and/or a decoder to generate an output representative of the input from the latent representation), or various combinations thereof. In some implementations, one or more models 108 can be pre-trained using, for example, image data, including but not limited to data 102.

The system 100 (e.g., based on operation of one or more GPUs) can render frames and/or portions of frames. The system 100 can render the frames to have relatively high quality and/or with relatively high compute intensity, such as at high frame rates and/or resolution.

For example, the system 100 can render, based at least on the application data for which to present a sequence of frames, a first portion of a first frame of the sequence of frames. The first portion can correspond to a first representation of one or more scenes indicated by the application.

The system 100 can render, based at least on the application data, a second portion of the first frame. The second portion can correspond to a second representation of the one or more scenes different from the first representation. For example, the first representation can be a view of an environment surrounding a player and the second representation can be a view through a sighting device, such as a scope. The first portion of the first frame can represent the view of the environment at a first timestamp and the second portion of the first frame can represent the view through the player's scope at the first timestamp.

The system 100 can render, based at least on the application data, a first portion of a second frame of the sequence of frames. The first portion of the second frame can be associated with the first portion of the first frame. Following the previous example, the first portion of the second frame can represent the view of the environment from the first portion of the first frame at a subsequent timestamp to the first timestamp. Rendered objects in the first portion of the second frame that correspond to rendered objects in the first portion of the first frame can have a change in position.

The system 100 can generate, as described further herein, and based at least on the application data, a second portion of the second frame of the sequence of frames. The second portion of the second frame can be associated with the second portion of the first frame. Following the previous example, the second portion of the second frame can represent the view through the sighting device from the second portion of the first frame at a subsequent timestamp to the first timestamp. Rendered objects in the second portion of the second frame that correspond to rendered objects in the second portion of the first frame can experience a change in position.

The system 100 can perform rendering on a single processing thread (e.g., using a GPU), to render the frames and portions thereof. For example, the system 100 can use the processing thread to render all portions of all frames (e.g., the first portion of the first frame, the second portion of the first frame, the first portion of the second frame, and the second portion of the second frame.

In some implementations, the system 100 can perform parallel processing (e.g., using one or more GPUs) to render the frames and portions thereof. For example, the system 100 can use a processing thread to render a particular portion of the frames. For example, the system 100 can use a first processing thread to render the first portions of the frames and a second processing thread to render the second portions of the frames. This can allow the system 100 to achieve greater utilization of computing resources of the system 100 and/or output frames with greater performance (e.g., greater frame rate, greater resolution, lower latency).

As described further herein, the system 100 can perform generation and/or interpolation of portions of frames using the model 108, which can allow for split-screen type display modes while maintaining and/or improving quality of outputted frames. In some implementations, the generation is performed based at least on detection of a target viewpoint for rendering or generation, including, for example, based at least on user viewpoint (e.g., view direction) detection. For example, referring further to FIG. 1, the system 100 can include at least one detector 104. The detector 104 can include one or more sensors (e.g., cameras) to capture viewpoint information. The detector 104 can include an eye tracker. The detector 104 can detect viewpoint information such as a direction in which a user of the application is viewing the display device. The detector 104 can use the viewpoint information to detect a location at which the direction intersects a frame, for example the location at which the direction intersects the first frame.

Referring further to FIG. 1, the system 100 can include at least one selector 106. The selector 106 can select a first view, such as a primary view, for which rendering is to be performed and/or to be performed at a greater rate relative to one or more second views (e.g., alternate views); the greater rate can include performing rendering of portions of frames for each frame corresponding to the first view. The selector 106 can select portions of frames that vary between frames to be the first view, e.g., depending on the view direction that the detector 104 determines.

For example, the selector 106 can dynamically determine primary and alternative views amongst a plurality of views. The selector can select one or more primary views amongst the plurality of views based at least on the location detected by detector 104. One or more of the remaining views in the plurality of views (e.g., views that are not selected as primary views) can be alternative views. The system can determine views for rendering based on the selected views. For example, the system 100 can render one or more portions of frames for the selected primary views and can generate one or more portions of frames for the alternative views using one or more models 108.

In some implementations, the selector 106 can statically determine primary and alternative views amongst a plurality of views. Primary and alternative views can be selected by selector 106 without information related to detection of a target viewpoint using detector 104. For example, in split-screen games in which multiple players can each be provided a corresponding screen (e.g., portion of the overall display area to be presented by a display device) by the system, a first view can be selected as a primary view for rendering images relating to a user of the system, and a second view can be selected as an alternative view for generating at least some images relating to content of a remote user (e.g., teammate).

In some implementations, the selector 106 can receive inputs indicative of a selection of views and/or content to present on given views according to one or more modalities. The modalities can include, for example, one or more of text, speech, image, video, or audio and/or voice inputs. For example, the selector 106 can receive, as input, a voice selection of a portion of the frames and/or screen as a primary view or secondary view. In some implementations, the selector 106 can receive the input as including content to present in a given view, e.g., to select a rear view, teammate view, or various other content. In some implementations, the selector 106 includes or is coupled with a language model (e.g., large language model (LLM), small language model (SLM), vision language model (VLM), multi-modal language model (MMLM), etc.) to process the inputs (e.g., process speech detected) to identify the selection of views and/or content to present.

Referring further to FIG. 1, one or more models 108 can include a diffusion model. The diffusion model can include a network, such as a denoising network. For example, in brief overview, the diffusion model can include a denoising network that is configured (e.g., pre-trained, trained, updated, fine-tuned, and/or has transfer learning applied) using training data of the data 102 that includes data elements to which noise is applied, and configuring the denoising network to modify the noise-augmented data elements to recover the (un-noised) data elements. The diffusion model can include (e.g., the denoising network can be implemented as) a latent diffusion model (LDM). For example, the diffusion model can perform operations on data mapped to a latent space.

The system 100 can configure the denoising network by causing the denoising network to reproduce example data (e.g., application data 102) to which noise has been applied. In some implementations, the system 100 configures the denoising network by conditioning the denoising network according to conditioning inputs, allowing the denoising network to generate outputs responsive to receiving inputs (e.g., at runtime/inference time).

For example, the system 100 can perform diffusion on one or more images x₀ (and/or image frames of video) of the data 102. The system 100 can perform diffusion by applying noise to (e.g., diffusing) the data 102, to determine training data points (e.g., diffused or noised data, such as noised images x_{T}). For example, the system 100 can add the noise to the data 102 (e.g., add a numerical value representing the noise in a same data format as the data 102, to the data 102) to determine the training data points. The system 100 can determine the noise to add to the data 102 using one or more noise distributions, which can indicate a noise level according to a time t, where 0<t<T, such that applying noise corresponding to the time T can result in the training data point x_{T} representing Gaussian noise. For example, the noise can be a sample of a distribution, such as a Gaussian distribution. The system 100 can apply the noise according to or with respect to a duration of time t. The duration of time t can be a value in a time interval, such as a value between zero and a maximum T of the time interval. The duration of time t can be a multiple of a number of discrete time steps between zero and T. The maximum T can correspond to an amount of time such that the result of applying noise for a duration of time T can be indistinguishable or almost indistinguishable from Gaussian noise. For example, the system 100 can apply diffusion to the image x₀ for the duration T to determine the training data point (e.g., noised image) x_{T}.

The denoising network can be implemented, for example and without limitation, using a U-Net, such as a convolutional neural network that includes downscaling and upscaling paths. The denoising network can receive the training data point x_{T} and determine an estimated output responsive to receiving the training data point x_{T}. The estimated output can have a same format as the training data point x_{T}, such as to be an image having a same number of rows of pixels and columns of pixels as the training data point x_{T} (and/or as data 102 compressed by the encoder, such as where the denoising network generates the estimated output and provides the estimated output to a decoder network for decoding up to the format of the data 102).

In some implementations, the system 100 can cause the diffusion model (e.g., an LDM as implemented by the denoising network) to learn to model the data distribution x via iterative denoising using the denoising network, and can be trained (e.g., updated) with denoising score matching. A noise schedule can be parameterized via a diffusion time over which logarithmic signal-to-noise ratio monotonically decreases. The denoising network can receive the diffused inputs that are parameterized with learnable parameters and can optimize a denoising score matching objective based on conditioning information (e.g., text prompt), target vector (e.g., random noise), forward diffusion process, reverse generation process, and so on. The input images x can be perturbed into a Gaussian random noise over a maximum diffusion time (e.g., time T). An iterative generative denoising process that employs the learned denoiser can be initialized from the Gaussian noise to synthesize novel data.

Referring further to FIG. 1, the system 100 can cause the model 108 to generate portions of frames, e.g., using diffusion and/or inpainting processes. For example, the system 100 can provide the second portion of the first frame and/or information regarding the second portion (e.g., text and/or data regarding the first portion) as input to the model 108 to cause the model 108 to generate the second portion of the second frame.

Referring further to FIG. 1, the system 100 can generate one or more portions of frames using frame generation techniques such as interpolation. For example, model 108 can identify a first timestamp of a first frame and can identify a second timestamp of a second frame. The model can compare the first timestamp with the second timestamp to determine a time difference between the first frame and the second frame. The model can generate one or more portions of the second frame that are synchronized with the first frame, by using application data associated with the first frame and using the time difference between the first frame and the second frame to interpolate one or more portions of the second frame to a target time. For example, the model can interpolate, based at least on the second portion of the first frame, the application data 102, and/or application data received from a remote device, the second portion of the second frame. The second portion of the second frame can be interpolated at the target time at which the second portion of the second frame was to have been rendered.

The system 100 can include an optical flow processor to perform interpolation. The optical flow processor can detect an optical flow between the first frame and the second frame to synchronize motion of the first frame with motion of the second frame. The optical flow processor can process data from the first and second frames to determine the indication of motion. For example, the optical flow processor can apply any one or more optical flow algorithms to detect motion of feature(s) represented by the first and second frames, such as to generate a flow map that includes one or more vectors representing the detected motion(s). For example, the optical flow processor can generate the vector that represents motion from the first frame to the second frame, such as to represent a pixel displacement from the first frame to the second frame. The flow map can assign a displacement (e.g., in X-and Y-coordinates) to one or more pixels of a flow map frame. As described herein, the optical flow processor can provide one or more outputs which can include interpolated views or portions of a frame based at least on the flow map and the time offset.

In some implementations, the system 100 can generate (e.g., interpolate and/or generate using an image or video generation model), for one or more views, content such as ads, including ads corresponding to the game. For example, the system 100 can render and/or generate the content based at least on one or more of player character names, game level, game statistics, or various combinations thereof, and use perform generation to facilitate presentation of advertisements (e.g., for a subset of frames and/or at varying frame rates). For example, the system 100 can periodically or according to a schedule or event detection, transition from a first one or more views to be displayed (e.g., as a single frame or split-screen) to a split-screen for presentation of an ad simultaneously with game content.

The system 100 can perform post-processing steps such as smoothing or noise reduction of the interpolated views. In some implementations, the post-processing includes a median filter, which can be used to modify one or more values of the output of the optical flow processor based on medians of associated values from proximate frames. In some implementations, the optical flow processor performs filtering operations. The system 100 can perform additional operations such as blending or checking outputs from the optical flow processor.

The processing circuitry of system 100 can present one or more frames of the sequence of frames at a frame rate. For example, the system can render the first portion of each frame of the sequence of frames at a frame rate (e.g., 60 frames per second (fps)), and can render the respective second portion of each frame of the sequence of frames at a lower frame rate than the frame rate (e.g., 30 fps). The rendered frames and generated frames can be presented as a sequence of frames using a display device 110.

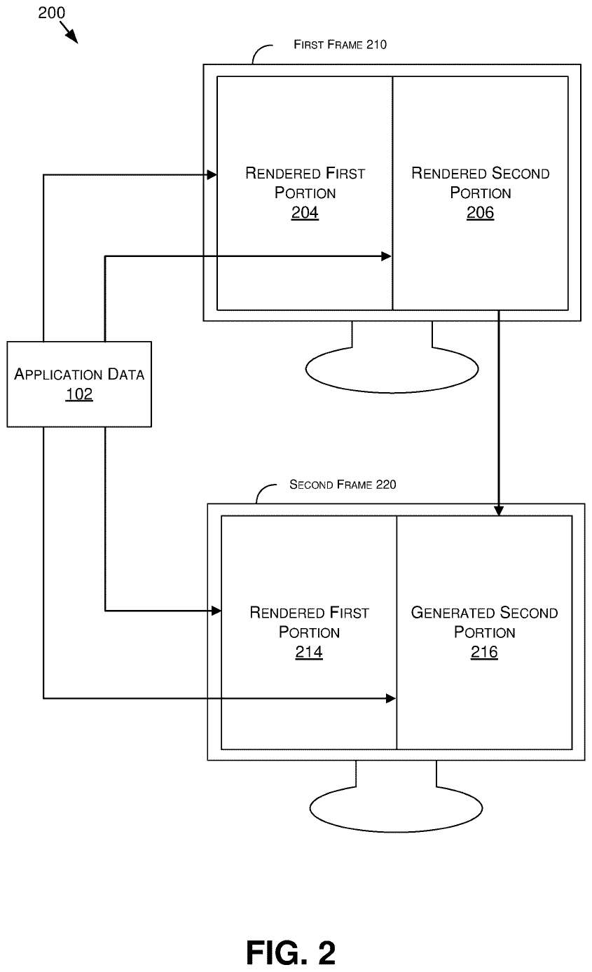

FIG. 2 is a block diagram 200 of an example display device for presenting a sequence of frames. A first frame 210 can be presented, comprising a rendered first portion 204 of the first frame 210 based on application data 102 and a rendered second portion 206 of the first frame 210 based on application data 102. For example, the system 100 can allow for a team view, wherein the first view is used to present rendered first portion 204 relating to a first user of the system and the second view is used to present rendered second portion 206 relating to content of a remote user (e.g., teammate). A second frame 220 can then be presented, comprising a second rendered first portion 214 of the second frame 220 based on application data 102 and a generated second portion 216 of the second frame 220 based on the rendered second portion 206 of the first frame 210 and application data 102. For example, the system 100 can allow for a team view involving a remote user, wherein the first view is used to present rendered first portion 214 relating to a user of the system and can present rendered second portion 216 relating to content of a remote user (e.g., teammate). While two portions are described in this example, the split-screen can include more than two portions, with at least a third portion functioning in the same manner as the second portion described herein.

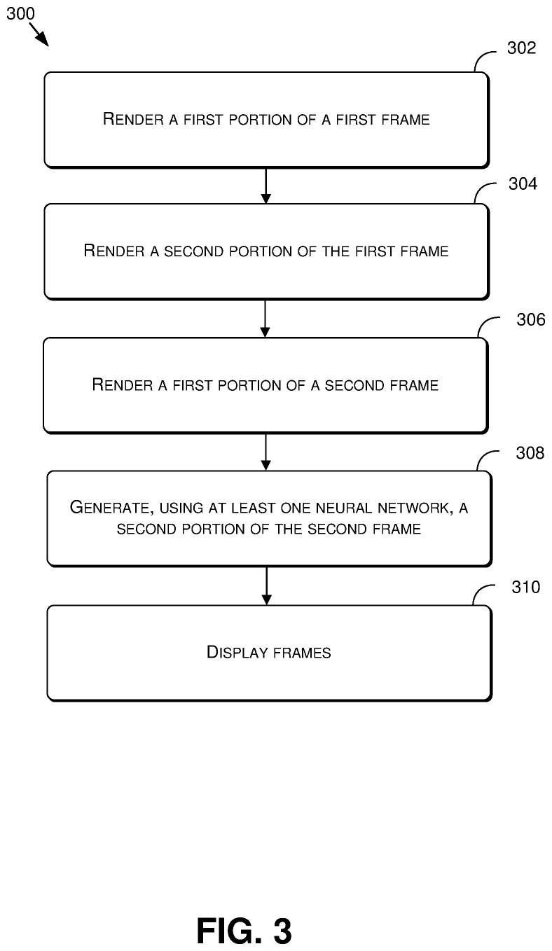

Now referring to FIG. 3, each block of method 300, described herein, comprises a computing process that can be performed using any combination of hardware, firmware, and/or software. For instance, various functions can be carried out by a processor executing instructions stored in memory. The method can be embodied as computer-usable instructions stored on computer storage media. The method can be provided by a standalone application, a service or hosted service (standalone or in combination with another hosted service), or a plug-in to another product, to name a few. In addition, method 300 is described, by way of example, with respect to the system of FIG. 1. However, this method can additionally or alternatively be executed by any one system, or any combination of systems, including, but not limited to, those described herein.

FIG. 3 is a flow diagram showing a method 300 for generating images for multiple views, in accordance with some embodiments of the present disclosure. The method 300, at block 302, includes rendering a first portion of a first frame in a sequence of frames, the first frame corresponding to a plurality of views. For example, one or more views of the plurality of views corresponding to the first frame can be selected as a primary view by the selector 106. The system 100 can render the primary view as the first portion of the first frame based on application data 102.

The method 300, at block 304, includes rendering a second portion of the first frame. For example, one or more views of the plurality of views corresponding to the first frame can be selected as a secondary view by the selector 106. The system 100 can render the secondary view as the second portion of the first frame based on application data 102. The system 100 can render the second portion of the first frame at a lower frame rate than the first portion of the first frame. For example, the system 100 can render image data for the secondary view at a lower frequency (e.g., frame rate) than rendering for the primary view, or other lower performance parameters such as resolution. For example, the system can render image data for the primary view of the sequence of frames at a target frame rate (e.g., 60 frames per second (fps) or 120 fps) and can render image data for the secondary view of the sequence of frames at a lower frame rate (e.g., 30 fps or 15 fps). This can allow for the system to achieve smooth animation while reducing compute resource usage.

The method 300, at block 306, includes rendering a first portion of a second frame in the sequence of frames, the second frame corresponding to a plurality of views. For example, one or more views of the plurality of views corresponding to the second frame can be selected as a primary view by the selector 106. The system 100 can render the primary view of the second frame as the first portion of the second frame based on application data 102 and associated with the first portion of the first frame.

The method 300, at block 308, includes generating, using at least one neural network, a second portion of the second frame based at least on application data 102 and the second portion of the first frame. The second portion of the second frame can be associated with the second portion of the first frame. The second portion of the second frame can be generated using frame generation techniques such as interpolation as described herein.

The method 300, at block 310, includes presenting the sequence of frames on a display device. For each frame in the sequence of frames, multiple views can be presented simultaneously. For example, the system 100 can display the first portion of the first frame and the second portion of the first frame as a split-screen, wherein a portion of the overall display area presents the first portion of the first frame and a different portion of the overall display area presents a second portion of the first frame. The system can then present the second frame after presenting the first frame in the sequence of frames. For example, the system 100 can display the first portion of the second frame and the second portion of the second frame as a split-screen, wherein a portion of the overall display area presents the first portion of the second frame and a different portion of the overall display area presents a second portion of the second frame.

Systems and methods in accordance with the present disclosure can allow for various use cases of multiple views (e.g., viewports, screens), including but not limited to for gaming applications. For example, the system can allow for a team view, such as where the first view is used to present rendered images relating to a user of the system and can present at least some generated images relating to content of a remote user (e.g., teammate). Application data related to the user of the system can be included in the system, and data relating to content of the remote user can be received from a remote device via a network connection, for example. The system can generate images related to the remote user through techniques such as interpolation as described herein. The system can allow for virtual devices in the in-game experience, e.g., to present a portable electronic device screen. The system can allow for picture-in-picture features, e.g., sighting devices, such as scopes. The system can allow for rear views relative to a movement direction of the primary view, such as for rear views of cameras or a rear-view mirror in a vehicle. Application data related to the primary view of the user (e.g., interior of the vehicle, front windshield) can be used by the system for rendering, and data related to a view through a rear-view mirror in a vehicle can be used by the system for interpolation, for example. The system can present both the rendered primary view and the interpolated rear-view mirror view simultaneously (e.g., side-by-side, overlapping) on a display device. The system can allow for multiple views of a cut scene to simultaneously show views at multiple sites, such as split-screen cut screens, wherein one view of the split-screen is rendered, and the other view of the split-screen is interpolated, with both views of the split-screen being presented simultaneously on a display device. The system can allow for maps, drone views and/or bird's eye views, or various other additional or alternative views of an environment. The system can present traversals of scenes into interpolated future states, such as to provide predicted views of future states relative to a rendered current state presented in a given view.

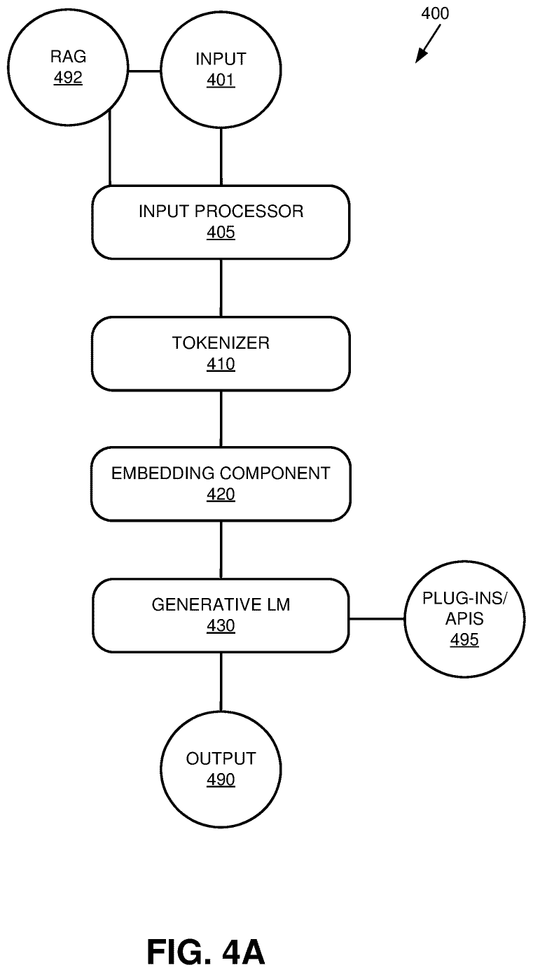

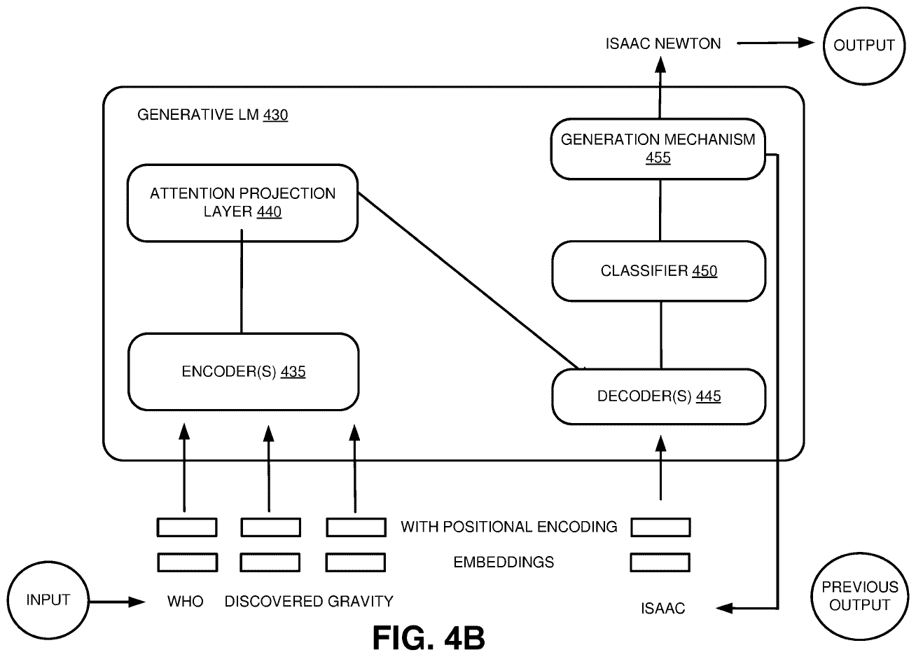

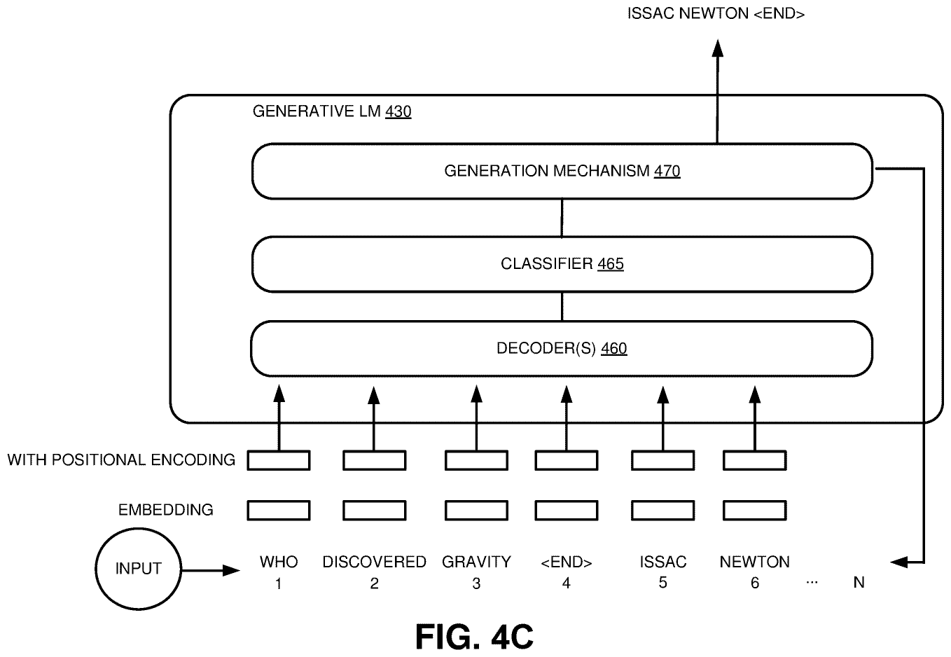

FIG. 4A is a block diagram of an example generative language model system 400 suitable for use in implementing at least some embodiments of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a SLM, a VLM, a MMLM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/SLM/VLM/MMLM/etc.). In some embodiments, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 492 (which may include one or more RAG models, and/or may be performed using the generative LM 430 itself) may be used to retrieve additional information to be used as part of the input 401 or prompt. RAG may be used to enhance the input to the LLM/SLM/VLM/MMLM/etc. with external knowledge, so that answers to specific questions or queries or requests are more relevant—such as in a case where specific knowledge is required. The RAG component 492 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 401 may be generated using the query or input to the model (e.g., a question, a request, etc.) in addition to data retrieved using the RAG component 492. In some embodiments, the input processor 405 may analyze the input 401 and communicate with the RAG component 492 (or the RAG component 492 may be part of the input processor 405, in embodiments) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 492 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular embodiment.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features—such as in the form of a spectrogram (e.g., a mel-spectrogram). In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some embodiments, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Content Streaming System

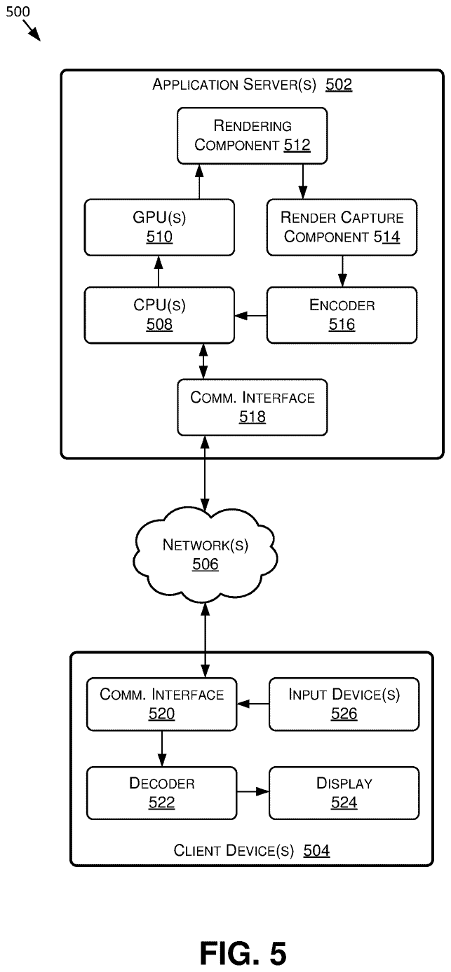

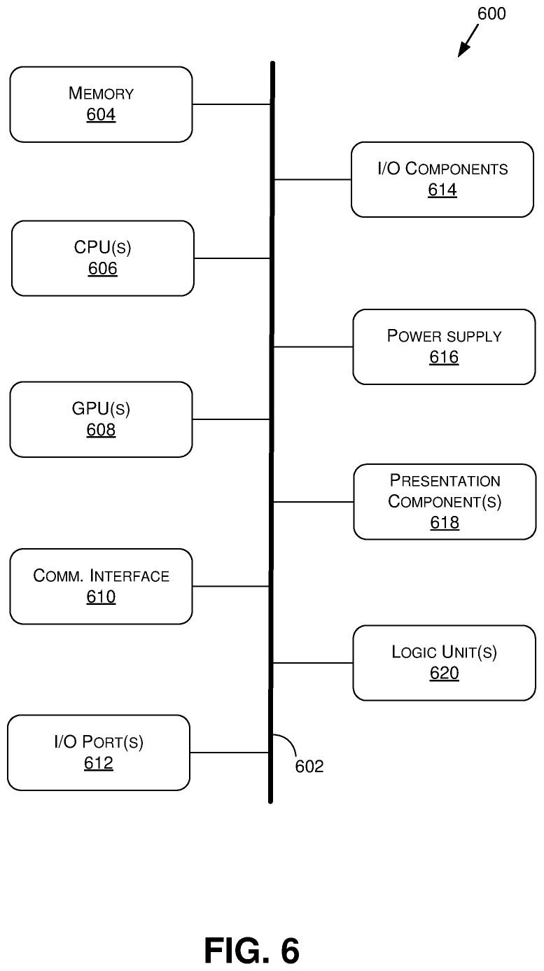

Now referring to FIG. 5, FIG. 5 is an example system diagram for a content streaming system 500, in accordance with some embodiments of the present disclosure. FIG. 5 includes application server(s) 502 (which can include similar components, features, and/or functionality to the example computing device 600 of FIG. 6), client device(s) 504 (which can include similar components, features, and/or functionality to the example computing device 600 of FIG. 6), and network(s) 506 (which can be similar to the network(s) described herein). In some embodiments of the present disclosure, the system 500 can be implemented. The application session can correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 500, for an application session, the client device(s) 504 can only receive input data in response to inputs to the input device(s), transmit the input data to the application server(s) 502, receive encoded display data from the application server(s) 502, and display the display data on the display 524. As such, the more computationally intense computing and processing is offloaded to the application server(s) 502 (e.g., rendering—in particular ray or path tracing—for graphical output of the application session is executed by the GPU(s) of the game server(s) 502). In other words, the application session is streamed to the client device(s) 504 from the application server(s) 502, thereby reducing the requirements of the client device(s) 504 for graphics processing and rendering.

For example, with respect to an instantiation of an application session, a client device 504 can be displaying a frame of the application session on the display 524 based on receiving the display data from the application server(s) 502. The client device 504 can receive an input to one of the input device(s) and generate input data in response. The client device 504 can transmit the input data to the application server(s) 502 via the communication interface 520 and over the network(s) 506 (e.g., the Internet), and the application server(s) 502 can receive the input data via the communication interface 518. The CPU(s) can receive the input data, process the input data, and transmit data to the GPU(s) that causes the GPU(s) to generate a rendering of the application session. For example, the input data can be representative of a movement of a character of the user in a game session of a game application, firing a weapon, reloading, passing a ball, turning a vehicle, etc. The rendering component 512 can render the application session (e.g., representative of the result of the input data) and the render capture component 514 can capture the rendering of the application session as display data (e.g., as image data capturing the rendered frame of the application session). The rendering of the application session can include ray or path-traced lighting and/or shadow effects, computed using one or more parallel processing units—such as GPUs, which can further employ the use of one or more dedicated hardware accelerators or processing cores to perform ray or path-tracing techniques—of the application server(s) 502. In some embodiments, one or more virtual machines (VMs)—e.g., including one or more virtual components, such as vGPUs, vCPUs, etc.—can be used by the application server(s) 502 to support the application sessions. The encoder 516 can then encode the display data to generate encoded display data and the encoded display data can be transmitted to the client device 504 over the network(s) 506 via the communication interface 518. The client device 504 can receive the encoded display data via the communication interface 520 and the decoder 522 can decode the encoded display data to generate the display data. The client device 504 can then display the display data via the display 524.

The systems and methods described herein can be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments can be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 6 is a block diagram of an example computing device(s) 600 suitable for use in implementing some embodiments of the present disclosure. Computing device 600 can include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 can comprise one or more virtual machines (VMs), and/or any of the components thereof can comprise virtual components (e.g., virtual hardware components). For non-limiting examples, one or more of the GPUs 608 can comprise one or more vGPUs, one or more of the CPUs 606 can comprise one or more vCPUs, and/or one or more of the logic units 620 can comprise one or more virtual logic units. As such, a computing device(s) 600 can include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, can be considered an I/O component 614 (e.g., if the display is a touch screen). As another example, the CPUs 606 and/or GPUs 608 can include memory (e.g., the memory 604 can be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 can represent one or more links or busses, such as an address bus, a data bus, a control bus, or a combination thereof. The interconnect system 602 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 can be directly connected to the memory 604. Further, the CPU 606 can be directly connected to the GPU 608. Where there is direct, or point-to-point connection between components, the interconnect system 602 can include a PCIe link to carry out the connection. In these examples, a PCI bus need not be included in the computing device 600.

The memory 604 can include any of a variety of computer-readable media. The computer-readable media can be any available media that can be accessed by the computing device 600. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 604 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 606 can be configured to execute at least some of the computer-readable instructions to control one or more components of the computing device 600 to perform one or more of the methods and/or processes described herein. The CPU(s) 606 can each include one or more cores (e.g., one, two, four, eight, twenty-eight, seventy-two, etc.) that are capable of handling a multitude of software threads simultaneously. The CPU(s) 606 can include any type of processor, and can include different types of processors depending on the type of computing device 600 implemented (e.g., processors with fewer cores for mobile devices and processors with more cores for servers). For example, depending on the type of computing device 600, the processor can be an Advanced RISC Machines (ARM) processor implemented using Reduced Instruction Set Computing (RISC) or an x86 processor implemented using Complex Instruction Set Computing (CISC). The computing device 600 can include one or more CPUs 606 in addition to one or more microprocessors or supplementary co-processors, such as math co-processors.

In addition to or alternatively from the CPU(s) 606, the GPU(s) 608 can be configured to execute at least some of the computer-readable instructions to control one or more components of the computing device 600 to perform one or more of the methods and/or processes described herein. One or more of the GPU(s) 608 can be an integrated GPU (e.g., with one or more of the CPU(s) 606 and/or one or more of the GPU(s) 608 can be a discrete GPU. In embodiments, one or more of the GPU(s) 608 can be a coprocessor of one or more of the CPU(s) 606. The GPU(s) 608 can be used by the computing device 600 to render graphics (e.g., 3D graphics) or perform general purpose computations. For example, the GPU(s) 608 can be used for General-Purpose computing on GPUs (GPGPU). The GPU(s) 608 can include hundreds or thousands of cores that are capable of handling hundreds or thousands of software threads simultaneously. The GPU(s) 608 can generate pixel data for output images in response to rendering commands (e.g., rendering commands from the CPU(s) 606 received via a host interface). The GPU(s) 608 can include graphics memory, such as display memory, for storing pixel data or any other suitable data, such as GPGPU data. The display memory can be included as part of the memory 604. The GPU(s) 608 can include two or more GPUs operating in parallel (e.g., via a link). The link can directly connect the GPUs (e.g., using NVLINK) or can connect the GPUs through a switch (e.g., using NVSwitch). When combined together, each GPU 608 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 606 and/or the GPU(s) 608, the logic unit(s) 620 can be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 can discretely or jointly perform any combination of the methods, processes and/or portions thereof. One or more of the logic units 620 can be part of and/or integrated in one or more of the CPU(s) 606 and/or the GPU(s) 608 and/or one or more of the logic units 620 can be discrete components or otherwise external to the CPU(s) 606 and/or the GPU(s) 608. In embodiments, one or more of the logic units 620 can be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 can include one or more receivers, transmitters, and/or transceivers that enable the computing device 600 to communicate with other computing devices via an electronic communication network, included wired and/or wireless communications. The communication interface 610 can include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 can include one or more data processing units (DPUs) to transmit data received over a network and/or through interconnect system 602 directly to (e.g., a memory of) one or more GPU(s) 608.

The I/O ports 612 can enable the computing device 600 to be logically coupled to other devices including the I/O components 614, the presentation component(s) 618, and/or other components, some of which can be built in to (e.g., integrated in) the computing device 600. Illustrative I/O components 614 include a microphone, mouse, keyboard, joystick, game pad, game controller, satellite dish, scanner, printer, wireless device, etc. The I/O components 614 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 can be include depth cameras, such as stereoscopic camera systems, infrared camera systems, RGB camera systems, touchscreen technology, and combinations of these, for gesture detection and recognition. Additionally, the computing device 600 can include accelerometers or gyroscopes (e.g., as part of an inertia measurement unit (IMU)) that enable detection of motion. In some examples, the output of the accelerometers or gyroscopes can be used by the computing device 600 to render immersive augmented reality or virtual reality.

The power supply 616 can include a hard-wired power supply, a battery power supply, or a combination thereof. The power supply 616 can provide power to the computing device 600 to enable the components of the computing device 600 to operate.

The presentation component(s) 618 can include a display (e.g., a monitor, a touch screen, a television screen, a heads-up-display (HUD), other display types, or a combination thereof), speakers, and/or other presentation components. The presentation component(s) 618 can receive data from other components (e.g., the GPU(s) 608, the CPU(s) 606, DPUs, etc.), and output the data (e.g., as an image, video, sound, etc.).

### Example Data Center

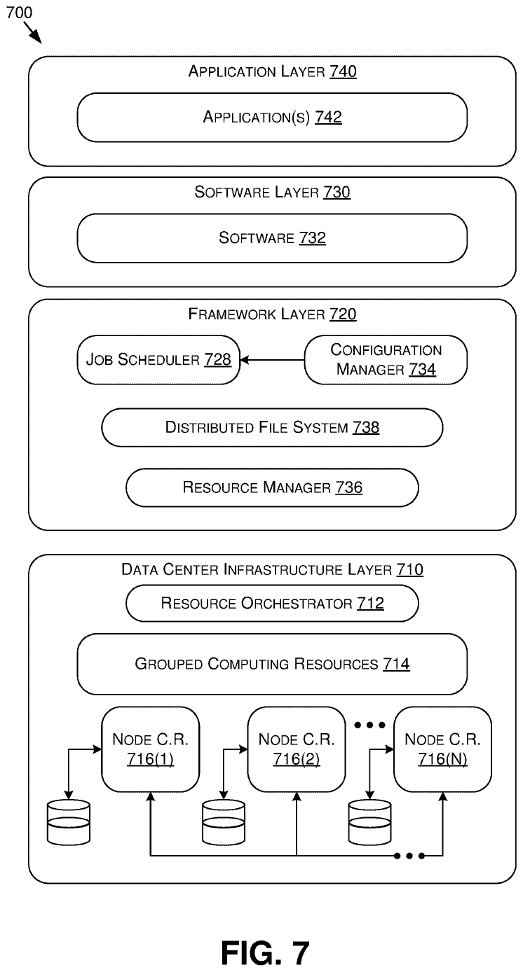

FIG. 7 illustrates an example data center 700 that can be used in at least one embodiments of the present disclosure. The data center 700 can include a data center infrastructure layer 710, a framework layer 720, a software layer 730, and/or an application layer 740.

As shown in FIG. 7, the data center infrastructure layer 710 can include a resource orchestrator 712, grouped computing resources 714, and node computing resources (“node C.R.s”) 716(1)-716(N), where “N” represents any whole, positive integer. In at least one embodiment, node C.R.s 716(1)-716(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) can correspond to a server having one or more of the above-mentioned computing resources. In addition, in some embodiments, the node C.R.s 716(1)-7161(N) can include one or more virtual components, such as vGPUs, vCPUs, and/or the like, and/or one or more of the node C.R.s 716(1)-716(N) can correspond to a virtual machine (VM).

In at least one embodiment, grouped computing resources 714 can include separate groupings of node C.R.s 716 housed within one or more racks (not shown), or many racks housed in data centers at various geographical locations (also not shown). Separate groupings of node C.R.s 716 within grouped computing resources 714 can include grouped compute, network, memory or storage resources that can be configured or allocated to support one or more workloads. In at least one embodiment, several node C.R.s 716 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 712 can configure or otherwise control one or more node C.R.s 716(1)-716(N) and/or grouped computing resources 714. In at least one embodiment, resource orchestrator 712 can include a software design infrastructure (SDI) management entity for the data center 700. The resource orchestrator 712 can include hardware, software, or some combination thereof.

In at least one embodiment, as shown in FIG. 7, framework layer 720 can include a job scheduler 728, a configuration manager 734, a resource manager 736, and/or a distributed file system 738. The framework layer 720 can include a framework to support software 732 of software layer 730 and/or one or more application(s) 742 of application layer 740. The software 732 or application(s) 742 can respectively include web-based service software or applications, such as those provided by Amazon Web Services, Google Cloud and Microsoft Azure. The framework layer 720 can be, but is not limited to, a type of free and open-source software web application framework such as Apache Spark™ (hereinafter “Spark”) that can utilize distributed file system 738 for large-scale data processing (e.g., “big data”). In at least one embodiment, job scheduler 728 can include a Spark driver to facilitate scheduling of workloads supported by various layers of data center 700. The configuration manager 734 can be capable of configuring different layers such as software layer 730 and framework layer 720 including Spark and distributed file system 738 for supporting large-scale data processing. The resource manager 736 can be capable of managing clustered or grouped computing resources mapped to or allocated for support of distributed file system 738 and job scheduler 728. In at least one embodiment, clustered or grouped computing resources can include grouped computing resource 714 at data center infrastructure layer 710. The resource manager 736 can coordinate with resource orchestrator 712 to manage these mapped or allocated computing resources.

In at least one embodiment, software 732 included in software layer 730 can include software used by at least portions of node C.R.s 716(1)-716(N), grouped computing resources 714, and/or distributed file system 738 of framework layer 720. One or more types of software can include, but are not limited to, Internet web page search software, e-mail virus scan software, database software, and streaming video content software.

In at least one embodiment, application(s) 742 included in application layer 740 can include one or more types of applications used by at least portions of node C.R.s 716(1)-716(N), grouped computing resources 714, and/or distributed file system 738 of framework layer 720. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 can implement any number and type of self-modifying actions based on any amount and type of data acquired in any technically feasible fashion. Self-modifying actions can relieve a data center operator of data center 700 from making possibly bad configuration decisions and possibly avoiding underutilized and/or poor performing portions of a data center.

The data center 700 can include tools, services, software or other resources to train one or more machine learning models or predict or infer information using one or more machine learning models according to one or more embodiments described herein. For example, a machine learning model(s) can be trained by calculating weight parameters according to a neural network architecture using software and/or computing resources described above with respect to the data center 700. In at least one embodiment, trained or deployed machine learning models corresponding to one or more neural networks can be used to infer or predict information using resources described above with respect to the data center 700 by using weight parameters calculated through one or more training techniques, such as but not limited to those described herein.

In at least one embodiment, the data center 700 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 600 of FIG. 6—e.g., each device can include similar components, features, and/or functionality of the computing device(s) 600. In addition, where backend devices (e.g., servers, NAS, etc.) are implemented, the backend devices can be included as part of a data center 700, an example of which is described in more detail herein with respect to FIG. 7.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server may not be included in a network environment—and one or more client-server network environments—in which case one or more servers can be included in a network environment. In peer-to-peer network environments, functionality described herein with respect to a server(s) can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 600 described herein with respect to FIG. 6. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
render, based at least on data of an application for which to present a sequence of frames, a first portion of a first frame of the sequence of frames and a second portion of the first frame;
render, based at least on the data, a first portion of a second frame of the sequence of frames, the first portion of the second frame associated with the first portion of the first frame;
generate, based at least on the data and the second portion of the first frame, a second portion of the second frame, the second portion of the second frame associated with the second portion of the first frame; and
present, using a display device, the sequence of frames.

2. The one or more processors of claim 1, wherein the processing circuitry is to present the sequence of frames at a frame rate, to render the respective first portion of each frame of the sequence of frames at the frame rate, and to render the respective second portion of each frame of the sequence of frames at a lower frame rate than the frame rate.

3. The one or more processors of claim 1, wherein the processing circuitry comprises at least one of a neural network or an optical flow processor to interpolate the second portion of the second frame.

4. The one or more processors of claim 1, wherein:
the first portion of the first frame corresponds to a first representation of one or more scenes indicated by the application; and
the second portion of the first frame corresponds to a second representation of the one or more scenes different from the first representation.

5. The one or more processors of claim 1, wherein the processing circuitry is to:
detect, according to an eye tracker, a direction in which a user of the application is viewing the display device, wherein the application comprises a game; and
map the first portion to a location at which the direction intersects the first frame.

6. The one or more processors of claim 1, wherein the processing circuitry is to use a first processing thread to render the first portion of the first frame and the first portion of the second frame, and to use a second processing thread to render the second portion of the first frame.

7. The one or more processors of claim 1, wherein the processing circuitry is to interpolate the second portion of the second frame based at least on data relating to the application received from a remote device.

8. The one or more processors of claim 1, wherein the one or more processors are comprised in at least one of:
a system for generating or presenting one or more of augmented reality content, virtual reality content, or mixed reality content;
a system for performing real-time streaming;
a system for performing simulation operations;
a system for performing collaborative content creation for 3D assets;
a system for performing deep learning operations;
a control system for an autonomous or semi-autonomous machine;
a perception system for an autonomous or semi-autonomous machine;
a system for performing digital twin operations;
a system for performing light transport simulation;
a system for performing remote operations;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

9. A system, comprising:
one or more processors to execute operations comprising:
rendering, based at least on data of an application for which to present a sequence of frames, a first portion of a first frame of the sequence of frames and a second portion of the first frame;
rendering, based at least on the data, a first portion of a second frame of the sequence of frames, the first portion of the second frame associated with the first portion of the first frame;
interpolating, based at least on the data and the second portion of the first frame, a second portion of the second frame, the second portion of the second frame associated with the second portion of the first frame; and
presenting, using a display device, the sequence of frames.

10. The system of claim 9, wherein the one or more processors are to present the sequence of frames at a frame rate, to render the respective first portion of each frame of the sequence of frames at the frame rate, and to render the respective second portion of each frame of the sequence of frames at a lower frame rate than the frame rate.

11. The system of claim 9, wherein the one or more processors comprise at least one of a neural network or an optical flow processor to interpolate the second portion of the second frame.

12. The system of claim 9, wherein:
the first portion of the first frame corresponds to a first representation of one or more scenes indicated by the application; and
the second portion of the first frame corresponds to a second representation of the one or more scenes different from the first representation.

13. The system of claim 9, wherein the one or more processors are to:
detect, according to an eye tracker, a direction in which a user of the application is viewing the display device, wherein the application comprises a game; and
map the first portion to a location at which the direction intersects the first frame.

14. The system of claim 9, wherein the one or more processors are to use a first processing thread to render the first portion of the first frame and the first portion of the second frame, and to use a second processing thread to render the second portion of the first frame.

15. The system of claim 9, wherein the one or more processors are to interpolate the second portion of the second frame based at least on data relating to the application received from a remote device.

16. The system of claim 9, wherein the system is comprised in at least one of:
a system for generating or presenting one or more of augmented reality content, virtual reality content, or mixed reality content;
a system for performing real-time streaming;
a system for performing simulation operations;
a system for performing collaborative content creation for 3D assets;
a system for performing deep learning operations;
a control system for an autonomous or semi-autonomous machine;
a perception system for an autonomous or semi-autonomous machine;
a system for performing digital twin operations;
a system for performing light transport simulation;
a system for performing remote operations;
a system implemented using an edge device;
a system implemented using a robot;
a system for performing conversational AI operations;
a system implementing one or more multi-model language models (MMLMs);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

17. A method, comprising:
rendering, based at least on application data, a first portion of a first frame of a sequence of frames and a second portion of the first frame;
rendering, based at least on the data, a first portion of a second frame of the sequence of frames, the first portion of the second frame associated with the first portion of the first frame;
interpolating, based at least on the data and the second portion of the first frame, a second portion of the second frame, the second portion of the second frame associated with the second portion of the first frame; and
presenting, using a display device, the sequence of frames.

18. The method of claim 17, further comprising:
presenting the sequence of frames at a frame rate;
rendering the respective first portion of each frame of the sequence of frames at the frame rate; and
rendering the respective second portion of each frame of the sequence of frames at a lower frame rate than the frame rate.

19. The method of claim 17, wherein at least one of a neural network or an optical flow processor is used to interpolate the second portion of the second frame.

20. The method of claim 17, wherein the first portion of the first frame corresponds to a first representation of one or more scenes indicated by the application; and
the second portion of the first frame corresponds to a second representation of the one or more scenes different from the first representation.
